(19) United States
(12) Patent Application Publication
(10) Pub. No.: US 2006/0141217 A1
(43) Pub. Date: Jun. 29, 2006

(54) Deep patterned nonwoven fabrics and method of making them

(76) Inventors: Clifford J. Ellis, Woodstock, GA (US); Terry C. Hill, Hendersonville, NC (US); Melpo Lambidonis, Cumming, GA (US); Stephen Avedis Baratian, Roswell, GA (US)

Correspondence Address: Maxwell J. Petersen;Pauley Petersen & Erickson, Suite 365, 2800 West Higgins Road, Hoffman Estates, IL, 60195, US

(21) Appl. No.: 11/025,630

(22) Filed: Dec. 29, 2004

(51) Int. Cl. B32B 3/00

(52) U.S. Cl. 428/156; 442/361; 442/415; 442/411

(57) ABSTRACT

A deep patterned nonwoven fabric including a plurality of raised portions having a first thickness of at least 1.5 mm and a plurality of depressed portions having a second thickness at least 50% less than the first thickness is prepared using a process which reduces and minimizes distortion of the raised portions. The process includes the steps of heating a precursor nonwoven fabric to soften its fibers and passing the heated nonwoven fabric to a nip defined by a patterned roll and an opposing member.

### BACKGROUND OF THE INVENTION

Nonwoven webs having deep patterns of embossments or debossments which extend partially, but not entirely through the nonwoven webs (herein “deep” patterned nonwoven webs,” or “DPNW's”) are useful in absorbent articles, such as personal care absorbent articles. Personal care absorbent articles typically include a liquid-permeable bodyside liner, a liquid-impermeable outer cover and an absorbent core between them. Absorbent articles may also include a surge or gush management layer between the bodyside liner and absorbent core, a dampness inhibiting (spacer) layer between the absorbent core and outer cover, and other optional layers.

When used in the bodyside liner, DPNW's help channel liquid insults into the absorbent article, and reduce sideways movement of liquid along the liner. DPNW's also help to ensnare and reduce sideways movement of solid or particulate extracts such as bowel movements.

When used in the surge or gush management layer, DPNW's help to distribute the liquid and channel it toward desired portions of the absorbent core. When used in the absorbent core, DPNW's provide pockets which can store superabsorbent particles, and maintain the pockets in a spaced apart relation.

When used in the dampness inhibiting layer, DPNW's provide air pockets which help form a temperature and humidity gradient between the absorbent core and the outer surface of the outer cover, resulting in less outer cover dampness. When used in the outer cover, DPNW's may provide a desirable pattern appearance or surface feel to the absorbent article.

DPNW's have been difficult to make without causing unwanted distortion and compression of the entire nonwoven web. There is a need or desire for DPNW's which maintain a relatively high loft in the regions between the embossments or debossments, and which substantially limit compression to the embossed or debossed regions.

### SUMMARY OF THE INVENTION

The present invention is directed to a nonwoven fabric including a plurality of raised portions having a first thickness of at least 1.5 mm, and a plurality of depressed portions between the raised portions having a second thickness which is at least 50% less than the first thickness of adjacent raised portions, wherein the nonwoven fabric has a ratio of depth to distortion of (herein “depth/distortion ratio”) of at least 5. The first thickness is about equal to a thickness of the nonwoven fabric before the depressed portions are formed.

For purposes of this invention, the depth of a depressed portion is determined by placing the nonwoven fabric on a flat horizontal surface and measuring the vertical distance from the lowest point in the depressed portion to the highest point on adjacent raised portions. The distortion of a raised portion is measured by drawing a first line tangent to a wall of the depressed portion and a second horizontal line parallel to and tangent to the upper surfaces of adjacent raised portions, such that the first and second lines intersect. The horizontal distance along the second line, between the point where it intersects the first line and the point where it contacts the surface of the nearest raised portion, is the distortion. The depth and distortion can be determined, for example, from sectional photographs of the nonwoven fabric taken by scanning electron microscopy (“SEM”), or simple light microscopy.

The present invention is also directed to a method of making a deep patterned nonwoven fabric including a plurality of raised portions having a first thickness of at least 1.5 mm and a plurality of depressed portions having a second thickness which is at least 50% less than the first thickness. The method includes the steps of forming or placing a nonwoven fabric on a conveyor belt, heating the nonwoven fabric to an elevated temperature to form a heated nonwoven fabric, and passing the heated nonwoven fabric through a nip defined by a patterned roll and the conveyor belt to form the deep patterned nonwoven fabric. The patterned roll includes an outer surface having a plurality of raised portions and depressed portions having a height difference of at least 50% of the first thickness of the nonwoven fabric, measured perpendicular to the outer surface. The closest distance between the depressed portions of the patterned roll and the conveyor belt is greater than or equal to the first thickness of the deep patterned nonwoven fabric. The closest distance between the raised portions on the patterned roll and the conveyor belt is less than or equal to the second thickness of the deep patterned nonwoven fabric.

### BRIEF DESCRIPTION OF THE DRAWINGS

FIG. 1 is a perspective view of a deep patterned nonwoven fabric of the invention.

FIG. 2 is a sectional view of the deep patterned nonwoven fabric of FIG. 1, taken along line 2-2.

FIG. 3 is an enlarged view of a portion of the deep patterned nonwoven fabric of FIG. 2, showing two raised portions and an intermediate depressed portion.

FIG. 4 is a plan view of another embodiment of a deep patterned nonwoven fabric of the invention.

FIG. 5 schematically illustrates a process for making the deep patterned nonwoven fabric of the invention.

FIG. 6 is an enlarged perspective view of a portion of the process of FIG. 5 including the interface between the patterned roller and the through-air bonding conveyor.

FIG. 7 schematically illustrates an alternative process for making the deep patterned nonwoven fabric of the invention.

FIG. 8 is a sectional photograph of a deep patterned nonwoven fabric prepared using a process similar to the one illustrated in FIG. 5.

### DEFINITIONS

As used herein, the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns (μm). (Note that to convert from osy to gsm, multiply osy by 33.91).

As used herein, “bonded carded webs” or “BCW” refers to nonwoven webs formed by carding processes as are known to those skilled in the art and further described, for example, in coassigned U.S. Pat. No. 4,488,928 to Alikhan and Schmidt which is incorporated herein in its entirety by reference. Briefly, carding processes involve starting with a blend of, for example, staple fibers with bonding fibers or other bonding components in a bulky batt that is combed or otherwise treated to provide a generally uniform basis weight. This web is heated or otherwise treated to activate the adhesive component resulting in an integrated usually lofty nonwoven material.

As used herein the term “spunbond fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartman; and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns (μm), more particularly, between about 10 and 20 microns (μm).

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, and are generally tacky when deposited onto a collecting surface.

As used herein, through-air bonding or “TAB” means a process of bonding a nonwoven bicomponent fiber web or a blend of bicomponent and monocomponent staple fibers in which air which is sufficiently hot to melt one of the polymers of which the fibers of the web are made is forced through the web. The air velocity is generally between 100 and 500 feet per minute and the dwell time may be as long as 6 seconds. The melting and resolidification of the polymer provides the bonding. Through air bonding has relatively restricted variability and since through-air bonding requires the melting of at least one component to accomplish bonding, it is useful for webs with two or more components like conjugate fibers, webs which include an adhesive, and webs which include blends of conjugate fibers and monocomponent staple fibers. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “monocomponent” fiber refers to a fiber formed from one or more extruders using only one polymer. This is not meant to exclude fibers formed from one polymer to which small amounts of additives have been added for coloration, anti-static properties, lubrication, hydrophilicity, etc. These additives, e.g. titanium dioxide for coloration, are generally present in an amount less than 5 weight percent and more typically about 2 weight percent.

As used herein, the term “multicomponent fibers” refers to fibers that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side-by-side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produce crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein, the term “garment” means any type of apparel which may be worn. This includes medical garments, industrial work wear and coveralls, undergarments, pants, shirts, jackets, gloves, socks, and the like.

As used herein, the term “personal care product” means diapers, training pants, absorbent underpants, adult incontinence products, and feminine hygiene products.

### DETAILED DESCRIPTION OF THE INVENTION

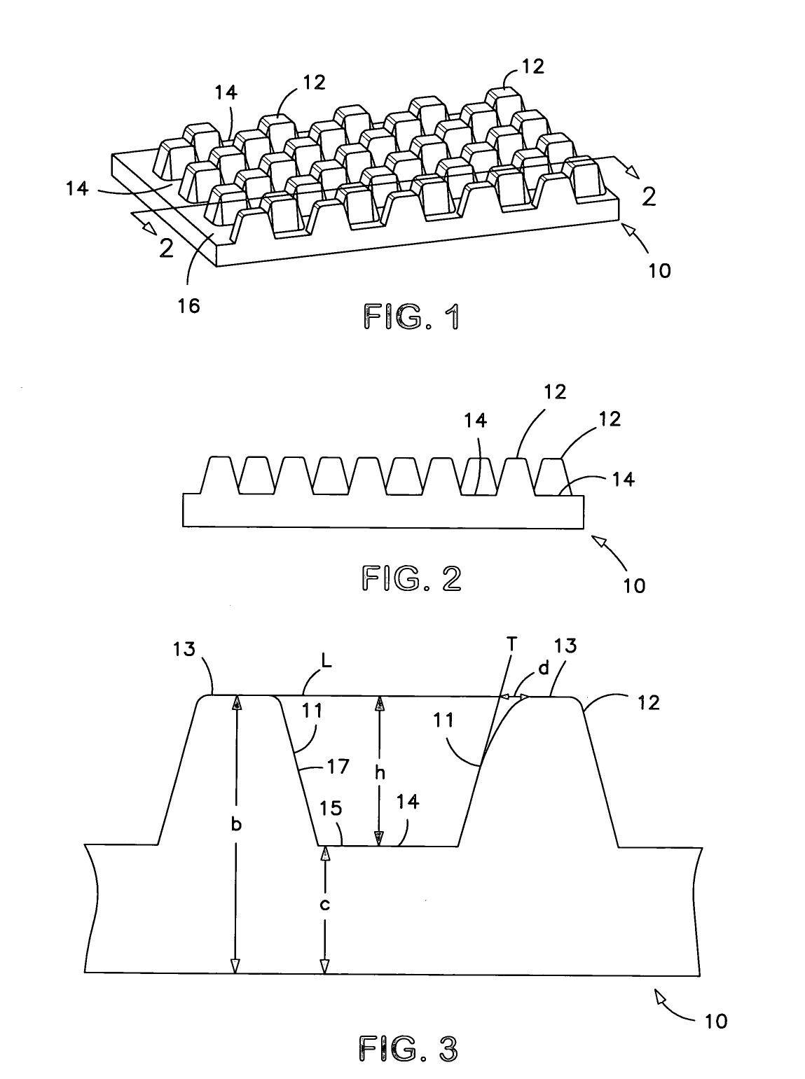

Referring to FIGS. 1-3, a deep patterned nonwoven fabric 10 of the invention includes a plurality of raised portions 12 having a first thickness “b” (measured perpendicular to a flat surface on which the nonwoven web rests, and through the nonwoven web), and a plurality of depressed portions 14 between the raised portions having a second thickness “c.” The first thickness “b” is at least about 1.5 mm, or at least about 2.0 mm, or at least about 2.5 mm, or at least about 3.0 mm. The difference between the first thickness “b” and the second thickness “c” is equal to the height “h” depicted in FIG. 3. On average, the second thickness “c” is at least about 50% less than the first thickness “b,” suitably at least about 55% less, or at least about 60% less, or at least about 65% less, or at least about 70% less. The average difference between the second thickness “c” and the first thickness “b” is not more than about 95% of the first thickness “b,” or not more than about 90%, or not more than about 85%, or not more than about 80%, or not more than about 75%. The average difference can be determined using scanning electron microscopy, or simple light microscopy, and by averaging 50 measurements as described below.

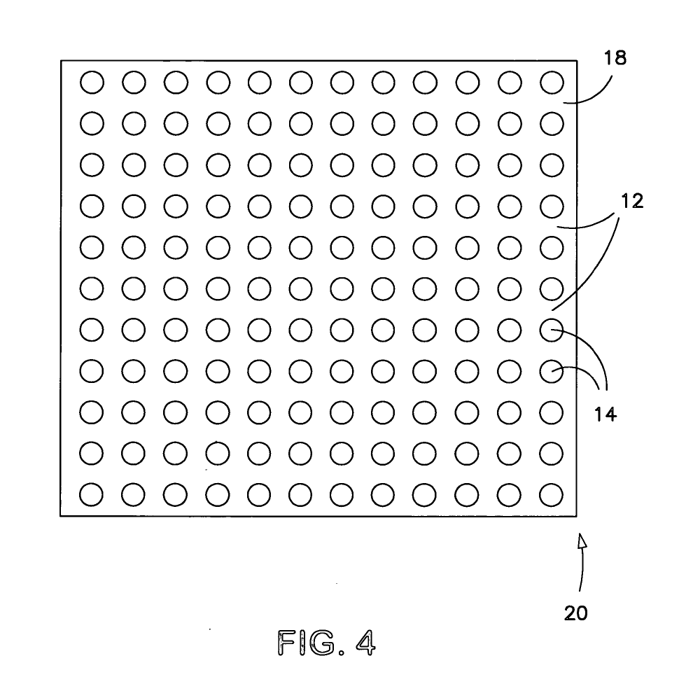

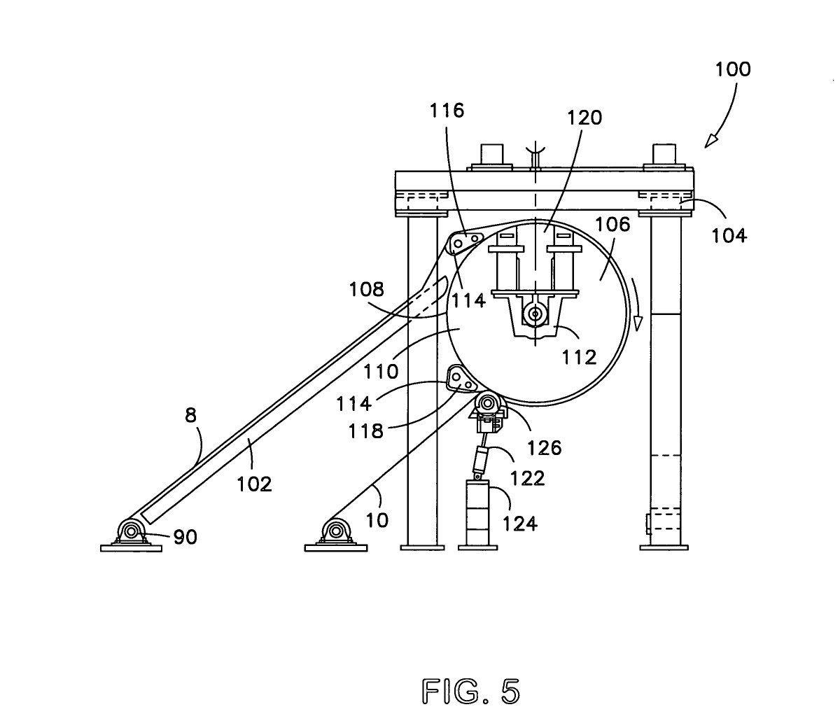

The deep patterned nonwoven fabric 10 may, in one embodiment, include a primary planar region 16 which is depressed and defines the depressed portions 14. In this embodiment (shown in FIG. 1), the depressed portions 14 are interconnected, while the raised portions 12 are isolated and do not touch one another. In another embodiment, shown in FIG. 4, a deep patterned nonwoven fabric 20 includes a primary planar region 18 which is raised and defines the raised portions 12. In this embodiment, the raised portions 12 are interconnected, while the depressed portions 14 are isolated and do not touch one another. In another embodiment of a deep patterned nonwoven fabric (not shown), the raised portions 12 and depressed portions 14 may have a “checkerboard” configuration such that neither the raised portions, nor the depressed portions, define a primary planar region relative to the other.

Referring again to FIG. 3, the height or depth of a depressed region 14, represented by the letter “h,” is the difference between the first thickness “b” and the second thickness “c” in that region. This can be determined using scanning electron microscopy (“SEM”) or light microscopy to take an enlarged photograph of a cross-section of deep patterned nonwoven fabric 10. Using an enlarged photograph, a line “L” is drawn from an upper surface 13 of a first raised portion 12 to an upper surface 13 of a second raised portion 12. The depth or height “h” is the distance between the line “L” and the lowest point on lower surface 15 of the intervening depressed portion 14.

Each raised portion 12 is also characterized by a distortion “d.” The distortion “d” is measured by first drawing a line “T” which is tangent to a side surface 11 of raised portion 12, and which intersects the line “L” extending between upper surface 13 of adjacent raised portions 12. If the side surface 11 is not perfectly straight, then the tangent line “T” should be tangent to a midpoint 17 of the side surface 11, located half way between the lower surface 14 and the line “L.” The tangent line “T” should extend from the lower surface 15 to the line “L,” and should represent the shortest distance (tangent to the surface 11) between the lower surface 15 and the line “L.” The distortion “d” is the distance along line “L” between the point of intersection with line “T” and the point where line “L” first contacts upper surface 13 of raised portion 12.

The distortion “d” typically reflects unwanted compression or depression of nonwoven fibers near the lateral edges of raised portions 12 due to embossing pins or other patterned instruments used to create depressed regions 14. The process of the invention (described below) is intended to minimize such unwanted compression or depression, thereby reducing the distortion “d,” and/or increasing the ratio (h/d) of depth to distortion, to levels not found in prior art deep patterned nonwoven fabrics. Typically, the distortion is a function of depth, and increases with depth. Therefore, a high ratio of depth to distortion is one characterizing feature of the deep patterned nonwoven fabrics of the invention.

The depth/distortion ratio of deep patterned nonwoven fabrics is defined herein as an average of fifty (50) individual measurements taken at random locations on the nonwoven fabric. At each location, the depth “h” and distortion “d” are determined as explained with respect to FIG. 3, and the ratio “h/d” is calculated. If an individual h/d measurement exceeds 50 or approaches infinity due to near zero distortion, then an arbitrary h/d value of 50 is assigned. The 50 h/d measurements are added together, and the sum is divided by 50 to determine the average value for the fabric. The deep patterned nonwoven fabrics of the invention have a depth/distortion ratio of at least about 5, suitably at least about 7, or at least about 9, or at least about 11, or at least about 13, or at least about 15, or at least about 17, or at least about 19, or at least about 21, or at least about 23, or at least about 25.

The deep patterned nonwoven fabrics of the invention may be formed from any suitable nonwoven web, including without limitation bonded carded webs, spunbond webs, meltblown webs, through-air bonded webs, and combinations thereof. Webs having relatively high loft and low bulk density are particularly suitable, including without limitation through-air bonded webs. The nonwoven web may have a bulk density of about 5-75 kilograms per cubic meter (“kcm”), suitably about 10-50 kcm, or about 15-45 kcm, prior to forming the deep pattern, and in the raised portions 12 after the deep pattern is formed. The bulk density in the depressed portions 14 increases relative to the depth of the depressed portions.

The nonwoven fibers (forming the nonwoven web or fabric) may be monocomponent, bicomponent or multi-component fibers, and may be formed of any suitable thermoplastic polymer(s). Examples of thermoplastic polymers include without limitation, polyolefins, polyamides, polyesters, polycarbonates, polystyrenes, thermoplastic elastomers, fluoropolymers, vinyl polymers, and blends and copolymers thereof. Mixtures of thermoplastic polymers can also be employed. Mixtures of thermoplastic fibers with other fibers, such as cotton or rayon, can also be employed.

Suitable polyolefins include, but are not limited to, polyethylene, polypropylene, polybutylene, and the like; suitable polyamides include, but are not limited to, nylon 6, nylon 6/6, nylon 10, nylon 12 and the like; and suitable polyesters include, but are not limited to, polyethylene terephthalate, polybutylene terephthalate and the like. Particularly suitable polymers for use in the present invention are polyolefins including polyethylene, for example, linear low density polyethylene, low density polyethylene, medium density polyethylene, high density polyethylene and blends thereof; polypropylene; polybutylene and copolymers as well as blends thereof. Additionally, the suitable fiber forming polymers may have thermoplastic elastomers blended therein. In addition, staple fibers may be employed in the nonwoven web as a binder.

In one embodiment, the starting nonwoven web is an unbonded carded web composed of 75% by weight bicomponent fibers and 25% by weight polyethylene terephthalate (polyester) fibers. The bicomponent fibers each include 55% by weight of a polypropylene core and 45% by weight of a sheath formed of low density or linear low density polyethylene. The unbonded carded web is passed through a hot air oven such as a through-air bonder, at a temperature of about 132° C. to soften the polyethylene sheath but not the polypropylene core of the bicomponent fibers. Bonding between adjacent fibers results from hot bicomponent fibers contacting each other. The resulting bonded web is immediately passed along a belt to a caliper roll having a three-dimensional patterned surface while the polyethylene sheath portions are still hot (about 90-100° C.) and very plastic.

As the caliper roll makes contact with the hot bonded web, the raised portions on the caliper roll immediately compress and depress corresponding portions of the nonwoven web to form depressed portions on the nonwoven web. The remaining (raised) portions on the nonwoven web are not compressed. Where the nonwoven fibers are compressed, because they are in a temperature-softened plastic state, they become permanently lodged in this depressed configuration as the nonwoven web then cools.

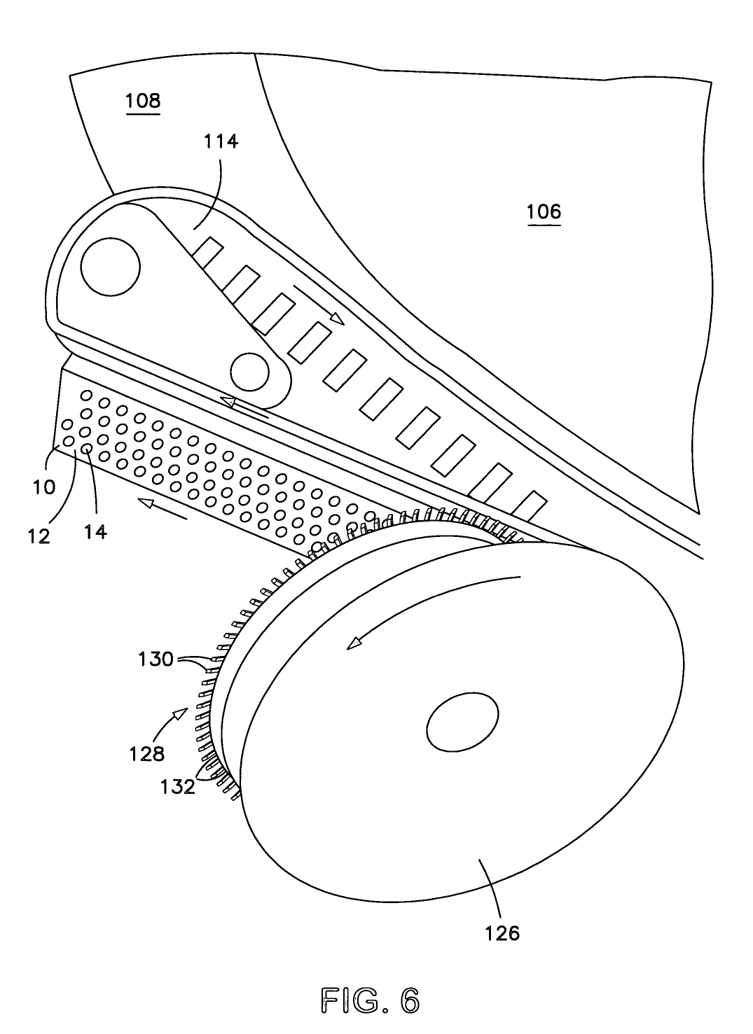

FIGS. 5 and 6 illustrate an apparatus 100 and process for making the deep patterned nonwoven fabric of the invention. Precursor nonwoven fabric 8, which can be an unbonded carded nonwoven web, is unwound from a source 90 and passed along a guide 102 to a through-air bonder 110 mounted to a frame assembly 104. The through-air bonder 110 includes a stationary housing 106 with a cylindrical surface 108, a through-air bonding oven 112, and an endless conveyor 114 extending around the cylindrical surface 108 and driven by pulleys 116 and 118.

The through-air bonder 110, and bonding oven 112 are of conventional design. The bonding oven 112 includes conventional apparatus for heating air and generating a flow of hot air upward through opening 120, through the endless conveyor 114 and the nonwoven fabric 8 carried by the conveyor 114.

As explained above, the hot air flowing through opening 120 softens the fibers (or portions of the fibers) of the precursor nonwoven fabric 8, and may cause bonding between the fibers. Then, the endless conveyor belt 114 carries the heated nonwoven fabric around the cylindrical surface 108 in the direction of the arrow shown in FIG. 5, and toward the caliper roll assembly 122. The linear traveling distance between the opening 120 and the caliper roll assembly 122, around the cylindrical surface 106, is relatively short. This distance may be on the order of about 10-100 cm, suitably about 20-50 cm, or about 25-35 cm.

The caliper roll assembly 122 includes a suitable mounting assembly 124 and a caliper roll 126 having a patterned outer surface. The mounting assembly 124 can be of any conventional construction which permits adjustment of the position of caliper roll 126 relative to endless conveyor belt 114. Referring to FIG. 6, the patterned outer surface 128 of caliper roll 126 may include a plurality of raised portions 130 and depressed portions 132 as shown, arranged so as to produce the desired pattern on the surface of the resulting deep patterned nonwoven fabric 10.

As illustrated in FIG. 6, any pressure applied to the nonwoven fabric by the caliper roll 126 is applied between the raised portions 130 of the patterned surface 128 of the caliper roll and the endless belt 114. The raised portions 130 are high enough, and the caliper roll 126 is positioned such that no pressure is applied by the depressed portions 132 of the caliper roll surface, and no pressure is exerted on the portions of the nonwoven fabric which define raised portions 12. Put another way, the closest distance between the depressed portions 132 of the patterned caliper roll and the conveyor belt 114 is greater than or equal to the first thickness of the deep patterned nonwoven fabric 10, and is greater than or equal to the thickness of the nonwoven web 8 prior to contacting the patterned roll. The closest distance between the raised portions 130 of the patterned caliper roll and the conveyor belt 114 is less than or equal to the second thickness of the deep patterned nonwoven fabric 10.

The temperature of the nonwoven fabric 8 passing between the patterned caliper roll 126 and the conveyor belt 114 is high enough that at least one polymer component of the fibers of the nonwoven fabric remains soft or plastic enough so that the depressed portions 14 are readily formed by the raised portions 130 of caliper roll 126 without causing significant distortion of the raised portions 12 on the nonwoven fabric. The nonwoven fabric temperature at this point should be between the melting temperature of the nonwoven fibers (or, if bicomponent, the melting temperature of the lowest melting portion of the bicomponent fibers) and a temperature which is about 20° C. less than said melting temperature. Suitably, the nonwoven fabric temperature at this point is about 3-10° C. less than said melting temperature. As explained above, the desired nonwoven fabric temperature approaching patterned caliper roll 126 may result from residual heat left over from a through-air bonding oven or other oven. Alternatively, the nonwoven fabric 8 may be heated before it approaches the patterned caliper roll using a dedicated heating process. The dedicated heating process may be used alone or as a secondary heating process.

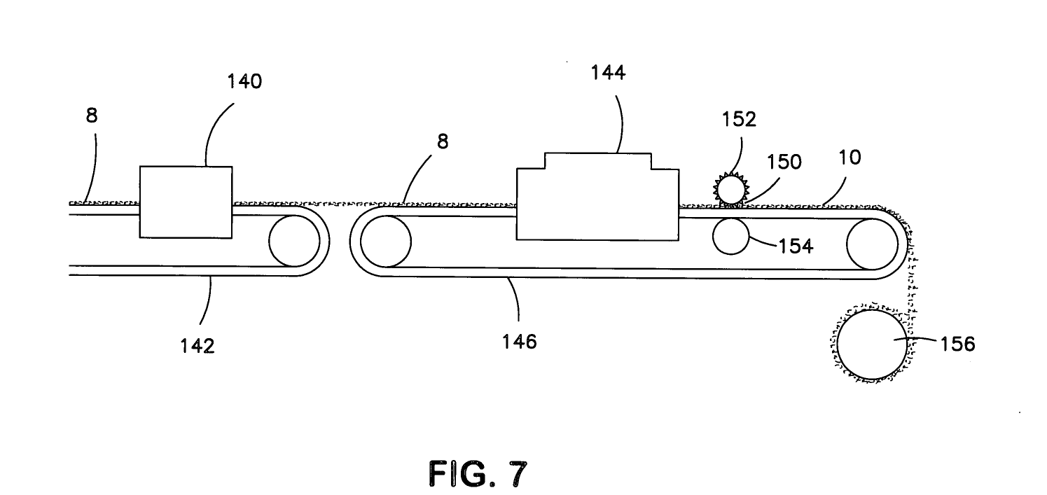

In the embodiment shown in FIGS. 5 and 6, the deep patterned nonwoven fabric is formed between a patterned caliper roll and an endless conveyor belt. In an alternative embodiment shown in FIG. 7, the deep patterned nonwoven fabric can be formed between a patterned caliper roll and a secondary anvil roll. Referring to FIG. 7, a precursor nonwoven fabric 8 is passed through a carding station 140 on a first conveyor 142, then through a through-air bonding station 144 on a second conveyor 146. The precursor nonwoven fabric 8, carried by conveyor 146, is then passed through a nip 150 defined by patterned roll 152 and anvil roll 154 while the precursor nonwoven fabric 8 is still warm from the through-air bonder 144. The patterned roll 152 and/or anvil roll 154 may also be heated. The resulting deep patterned nonwoven fabric 10 can then be wound onto storage roll 156. Whether the nip is defined by a patterned caliper roll and a conveyor belt, or between a patterned caliper roll and a smooth anvil roll, the deep patterned nonwoven fabric 10 can be formed with minimal distortion by passing the precursor nonwoven fabric through the nip at the desired elevated temperature, as explained above.

The deep patterned nonwoven fabric may be used in a variety of personal care products, including without limitation personal care absorbent products, as described above.

### EXAMPLE

A deep patterned through-air bonded nonwoven fabric was prepared using a process similar to the caliper roll process illustrated in FIG. 5 and described above. The nonwoven fabric included 75% by weight 1.5 denier bicomponent fibers having an outer sheath formed of polyethylene and an inner core formed of polypropylene, and 25% by weight 6.0 denier polyester fibers. The bicomponent fibers were sold by FiberVisions Co. under the trade name ESC-215A. The polyester fibers were sold by Invista Co. under the trade name T-295. The through-air bonding temperature was 132° C.

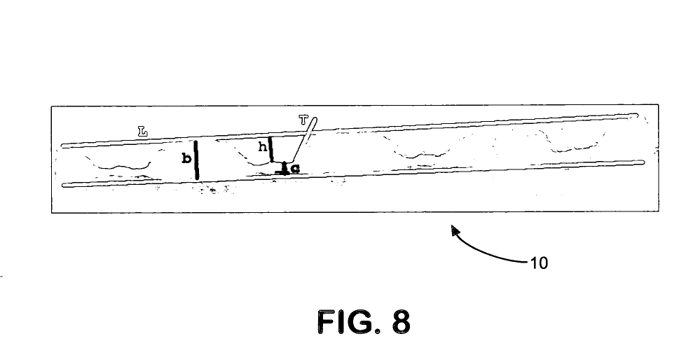

Prior to forming the deep pattern, the nonwoven fabric had a bulk density of 27 kcm. The deep patterned nonwoven fabric, which is illustrated in FIG. 8, had a first thickness “b” of 2.8 mm, a second thickness “c” of 0.9 mm, a pattern height “h” of 1.9 mm, and a depth/distortion ratio (h/d) of 11.0, with the values each reflecting averages of 50 measurements based on photographs taken using simple light microscopy.

While the embodiments of the invention described above are exemplary, various modifications and improvements can be made without departing from the spirit and scope of the invention. The scope of the invention is indicated by the appended claims, and all changes that fall within the meaning and range of equivalents are intended to be embraced therein.

We claim:

1. A deep patterned nonwoven fabric, comprising:
a plurality of raised portions having a first thickness of at least about 1.5 mm; and
a plurality of depressed portions between the raised portions having a second thickness which is about 50-95% less than the first thickness of adjacent raised portions;
wherein the nonwoven fabric has a depth/distortion ratio of at least about 5.

2. The deep patterned nonwoven fabric of claim 1, wherein the second thickness is at least about 55% less than the first thickness.

3. The deep patterned nonwoven fabric of claim 1, wherein the second thickness is at least about 60% less than the first thickness.

4. The deep patterned nonwoven fabric of claim 1, wherein the second thickness is at least about 65% less than the first thickness.

5. The deep patterned nonwoven fabric of claim 1, wherein the second thickness is at least about 70% less than the first thickness.

6. The deep patterned nonwoven fabric of claim 1, wherein the raised portions are isolated and the depressed portions are interconnected.

7. The deep patterned nonwoven fabric of claim 1, wherein the depressed portions are isolated and the raised portions are interconnected.

8. The deep patterned nonwoven fabric of claim 1, wherein the depth/distortion ratio is at least about 7.

9. The deep patterned nonwoven fabric of claim 1, wherein the depth/distortion ratio is at least about 9.

10. The deep patterned nonwoven fabric of claim 1, wherein the depth/distortion ratio is at least about 13.

11. The deep patterned nonwoven fabric of claim 1, wherein the depth/distortion ratio is at least about 17.

12. The deep patterned nonwoven fabric of claim 1, wherein the fabric comprises polyolefin fibers.

13. The deep patterned nonwoven fabric of claim 1, wherein the fabric comprises bicomponent fibers.

14. The deep patterned nonwoven fabric of claim 1, wherein the fabric comprises a mixture of bicomponent polyolefin fibers and polyester fibers.

15. A deep patterned nonwoven fabric, comprising:
a through-air bonded web having a plurality of raised portions and a plurality of depressed portions between the raised portions;
the raised portions having a first thickness of at least about 1.5 mm and a bulk density of about 10-50 kcm;
the depressed portions having a second thickness about 50-95% less than the first thickness of adjacent raised portions;
wherein the nonwoven fabric has a depth/distortion ratio of at least about 5.

16. The deep patterned nonwoven fabric of claim 15, wherein the raised portions have a bulk density of about 15-45 kcm.

17. The deep patterned nonwoven fabric of claim 15, wherein the raised portions have a first thickness of at least about 2.5 mm.

18. The deep patterned nonwoven fabric of claim 15, wherein the raised portions have a first thickness of at least about 3.0 mm.

19. The deep patterned nonwoven fabric of claim 15, wherein the fabric comprises thermoplastic fibers.

20. The deep patterned nonwoven fabric of claim 15, wherein the fabric comprises bicomponent polyolefin fibers.

21. The deep patterned nonwoven fabric of claim 20, wherein the fabric further comprises polyester fibers.

22. The nonwoven fabric of claim 19, wherein the fabric comprises a mixture of two or more different thermoplastic fibers.

23. The nonwoven fabric of claim 19, wherein the fabric comprises a mixture of thermoplastic fibers and cotton fibers.

24. The nonwoven fabric of claim 19, wherein the fabric comprises a mixture of thermoplastic fibers and rayon fibers.

25. A method of making a deep patterned nonwoven fabric including a plurality of raised portions having a first thickness of at least about 1.5 mm and a plurality of depressed portions having a second thickness at least 50% less than the first thickness, the method comprising the steps of:
forming or placing a nonwoven fabric on a conveyor belt;
heating the nonwoven fabric to an elevated temperature to form a heated nonwoven fabric; and
passing the heated nonwoven fabric through a nip defined in part by a patterned roll to form the deep patterned nonwoven fabric.

26. The method of claim 25, wherein the nip is defined by the patterned roll and the conveyor belt.

27. The method of claim 25, wherein the nip is defined by the patterned roll and a smooth roll.

28. The method of claim 25, wherein the nonwoven fabric is heated using a through-air bonding process.

29. The method of claim 25, wherein the nonwoven fabric comprises thermoplastic polymer fibers, and is heated to a temperature between a melting point of the thermoplastic polymer and about 20° C. less than the melting point.

30. The method of claim 25, wherein the nonwoven fabric comprises bicomponent thermoplastic fibers, and is heated to a temperature between a melting point of a lowest melting component of the fibers and about 20° C. less than the melting point.

31. The method of claim 25, wherein the patterned roll includes a plurality of raised portions separated from the conveyor belt by a distance less than or equal to the second thickness of the deep patterned nonwoven fabric.

32. The method of claim 25, wherein the patterned roll includes a plurality of depressed portions separated from the conveyor belt by a distance greater than or equal to the first thickness of the deep patterned nonwoven fabric.

33. The method of claim 28, wherein the through-air bonding process comprises a bonding oven separated from the nip by a traveling distance of about 10-100 cm.

34. The method of claim 33, wherein the traveling distance is about 20-50 cm.
